(19) United States
(12) Patent Application Publication
(10) Pub. No.: US 2024/0025203 A1
(43) Pub. Date: Jan. 25, 2024

(54) Caddy for Paint Bucket

(71) Applicant: Manuel Geris, Canyon Lake, CA (US)

(72) Inventor: Manuel Geris, Canyon Lake, CA (US)

(21) Appl. No.: 18/223,882

(22) Filed: Jul. 19, 2023

Related U.S. Application Data
(60) Provisional application No. 63/368,950, filed on Jul. 20, 2022.

(51) Int. Cl. B44D 3/12

(52) U.S. Cl. CPC B44D 3/123; B44D 3/128

(57) ABSTRACT

A caddy for the paint container when viewed from the top is comprised of a chord segment and a corresponding arc segment, the chord segment and arc segment being the front wall and rear wall respectively of the caddy with a bottom that joins the walls forming an open-top reservoir. The outer surface of the front wall comprises a matrix of cones so as to form an irregular surface that a paint roller may utilize to distribute paint about the paint roller. The caddy contains a magnet within the reservoir to secure a paintbrush and a deck where openings or recesses may secure one or more tools. Other disclosed embodiments include a caddy where the deck has been replaced by a handle or by a secondary paint reservoir.

### CROSS-REFERENCE TO RELATED APPLICATIONS

This application claims priority from U.S. Provisional Patent Application No. 63/368,950 filed on Jul. 20, 2022. The entire disclosure of the prior application is considered to be part of the disclosure of the accompanying application and is hereby incorporated by reference.

### BACKGROUND OF THE INVENTION

### 1. Field of the Invention

This invention relates to a tool that may be utilized by residential and industrial painters to make more effective use of their time when both a paint roller and a paintbrush are in use at the same time. In particular, the tool being a caddy that may be inserted onto the rim of a paint bucket. The caddy comprises a reservoir to hold paint, a flat surface made irregular by the presence of multiple cones to be used when removing excess paint from a paint roller, means to secure a paintbrush to the reservoir, a deck to mount accessories such as a putty knife, and a handle to facilitate using the caddy with a hand or a second reservoir.

### 2. Description of the Related Art

Presently there are two basic tools used by residential and industrial painters, or simply painters, to apply paint: a paintbrush and a paint roller. Paint may also be applied by using an air sprayer. However, due to problems in precisely directing the spray of paint to the surface where it is to be applied and ambient conditions such as wind, air sprayers are generally disfavored by painters. A paint roller is used to apply paint to larger surfaces and works well for such a purpose. The painter will immerse the paint roller in a container containing paint and then direct the paint roller against an irregular surface that is typically found in the container. The painter will then roll the paint roller across the irregular surface to simultaneously remove excess paint and to evenly distribute the paint about the surface of the paint roller. The painter may then direct the paint roller to the surface that is to be painted, and with a rolling motion, spread the paint quickly onto a large part of the surface. While a paint roller works well for painting broad surfaces, it is not possible to use a paint roller where the painting is to be done with precision. In such circumstances, a paintbrush is best. Much like a paint roller, the painter will first dip the brush portion of a paintbrush into a paint container and then remove excess paint by pressing the brush portion along the edge of the paint container. This process will uniformly spread the paint within the brush portion. At this point, the paintbrush is ready to be used along edges or other surfaces where a paint roller may not be used.

Since a painter requires both a paint roller and a paintbrush to cover all portions of the surface to be painted, it is highly beneficial to the painter to have simultaneous access to both a paint roller and a paintbrush. While on a ladder, it is difficult to have both a paint roller and a paintbrush as there is not enough space, while confined to a ladder, for a painter to switch between the two. When a painter is required to use a ladder, the painter will pour a desired amount of paint into a paint container. Generally speaking, a container has a capacity of 2 gallons and its top rim has a diameter of approximately 9.25 inches. The painter is able to hang the paint container on the ladder while working as devices exist specifically to support the hanging of a paint container on a ladder. The painter will also insert into the container a flat grate, having an irregular surface, to use for removing excess paint from the roller and to evenly. distribute the paint about the surface of the paint roller. Although a 2-gallon container is only intended to be used by a paint roller, the painter may add a device to the top rim of the container to accommodate a paintbrush while on the ladder. While many patents have been applied for and issued that in some respect claim a device that is attached to the top rim of this container, there is room for an improved device.

One patent that has been issued for a caddy that may be placed onto the rim of a paint container is Unites States patent 11,279,169 to Martin Tracy titled “Paint tray for use with rollers and brushes” which discloses a caddy, suitable for use in a paint bucket, that comprises a paint roller grid mounted to an upper shelf that includes a reservoir intended for separate use with a paintbrush. This upper shelf includes a semicircular rim and lip for mounting the tool or paint tray to the top of a circular bucket and the paint roller grid extends from an opposite straight edge of the shelf and downward into the paint bucket. paint roller and a paintbrush can then be stored and used separately to reduce waste, messes, and clean up. The paint roller grid and the shelf can be an integral one-piece member, and they can be joined by a living hinge if molded as a plastic member. However, the Tracy caddy (i) has movable parts that may be damaged, (ii) does not provide a means to secure a paintbrush to the upper shelf, (iii) does not provide a means to secure any other tools such as a screwdriver or putty knife, (iv) does not provide a handle so that the caddy may be easily lifted from the paint container and used solely as a small paint container, and (v) does not provide for a second reservoir to hold a second color of paint.

Another patent has been issued for a caddy that may be placed onto the rim of a paint container is U.S. Pat. No. 5,207,348 to Eric Fischer et al titled “Auxiliary paint brush bucket” which discloses a caddy that has a planar front wall, an arcuate rear wall and a bottom wall to form an open top container. The front surface of the front wall has a plurality of conical-shaped raised bumps thereon formed in a predetermined pattern so that a paint roller may be squeezed against the front wall surface to remove excess paint and it runs down the channels between the respective bumps. A unique pair of laterally spaced clips are formed on the top edge of the rear wall so that it can be removably installed along the inner surface of either a two-gallon or five-gallon paint bucket, Again, as with the Tracy patent, the Fischer patent (i) does not provide a means to secure a paintbrush to the upper shelf, (ii) does not provide a means to secure any other tools such as a screwdriver or putty knife, (iii) does not provide a handle so that the caddy may be easily lifted from the paint container and used solely as a small paint container, and (iv) does not provide for a second reservoir to hold a second color of paint.

Another patent has been issued for a caddy that may be placed onto the rim of a paint container is U.S. Pat. No. 5,261,577 to Gilbert Goldstein et al titled “Paint brush caddy” which discloses a caddy adapted to hold a paintbrush in association with a paint container and to prevent dripping from such brush onto the floor comprising in its basic elements a container into which the paintbrush is inserted and which is enclosed to prevent leakage therefrom, and means to affix such container in a removable fashion to the lip of a paint bucket to hold the container in a fixed position on said bucket. However, the Goldstein patent does not (i) does not provide a reservoir adapted to hold paint, (ii) does not provide a means to secure any other tools such as a screwdriver or putty knife, (iii) does not provide a handle so that the caddy may be easily lifted from the paint container and used solely as a small paint container, and (iv) does not provide for a second reservoir to hold a second color of paint.

Other patents that have been issued for similar caddies include United States design patents 327,148, 444,278, and 877,997 and utility patent 8,887,940 to Taras Kiceniuk et al. However, none of these design and utility patents include all of the novel features provided for in the applicant” disclosed caddy.

Known caddies that may be positioned about the rim of a paint container lack one or more features that are necessary for a painter to work efficiently. These features include a paintbrush holder and a means to secure the paintbrush to he paintbrush holder, one or two secondary reservoirs that may hold paint for touch-up work, a deck having features that enable one or more tools to be attached, and a handle for using the caddy separate from the paint container for touch up work, and more.

### BRIEF SUMMA RY OF THE IN VENT ION

In view of the disadvantages of known caddies present in the prior art as previously discussed, the present invention discloses an improved caddy. The primary purpose of the present invention, which will be disclosed in greater detail, is to provide a new and improved paint brush caddy that provides painters with convenient and ergonomic means of transporting and applying paint.

What is disclosed herein is a paint brush caddy comprising a reservoir adapted to hold additional paint, for either touch-up work or trim work in a secondary color, that may be removably fixed onto the rim of a paint container for easy access by a painter. Moreover, a paintbrush may rest within the reservoir and be secured thereto by a magnet. Although the caddy of the present invention may be broadly described as in this paragraph, there are additional features and embodiments of the caddy of the present invention that will be described in the following paragraphs.

It is to be understood that the invention is not limited in its application to the details of construction and to the arrangements of the components set forth in the following paragraphs. The invention is capable of other embodiments and of being practiced and carried out in various ways. Additionally, it is understood that the phraseology and terminology used here are solely for the purposes of describing the invention and should not be regarded as limiting.

Moreover, the abstract provided with this application is to enable the U.S. Patent and Trademark Office and those utilizing services provided by this office, to determine the nature and essence of the technical disclosure of this application without the necessity of a complete reading of the disclosure. However, the abstract is neither intended to define the invention of the application, which is measured by the claims, nor is it intended to be limiting as to the scope of the invention in any way.

It is therefore an object of the present invention to provide a caddy that may be removably fixed to the rim of a paint container, the caddy further comprising a reservoir containing paint, thus allowing a painter to quickly and efficiently apply the paint within the reservoir by using a brush.

It is another object of the present invention to provide a caddy that may be removably fixed to the rim of a paint container, the caddy further comprising a reservoir containing paint and a magnet to secure a paint brush against, thus allowing a painter to quickly and efficiently apply the paint within the reservoir by using a brush.

It is another object of the present invention to provide a caddy that may be removably fixed to the rim of a paint container, the caddy further comprising a reservoir containing paint and having an irregular planar surface whereon a paint roller may be utilized upon, thus allowing a painter to quickly and efficiently apply the paint within the reservoir by using either a paintbrush or a roller.

It is another object of the present invention to provide a caddy comprising a reservoir that may contain paint and further comprising a deck whereon additional tools may be secured thereto such as screwdrivers, putty knife, razor blades, and more.

It is another object of the present invention to provide a caddy that may be removably fixed to the rim of a paint container, the caddy further comprising a reservoir containing paint and having a handle so that the caddy may be easily lifted from the paint container and used independently from the paint container.

It is another object of the present invention to provide a caddy comprising a reservoir that may contain paint and further comprising a secondary reservoir where a secondary color paint may be stored.

These together with other objects of the invention, along with the various features of novelty which characterize the invention, are pointed out with particularity in the claims forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF DRAWINGS

The present invention will become more fully understood from the detailed description and accompanying drawings. Other systems, methods, features, and advantages of the invention will be or will become apparent to one with skill in the art upon examination of the following figures and detailed description. It is intended that all such additional systems methods, features, and advantages be included within this description, be within the scope of the invention, and be protected by the accompanying claims. Component parts shown in the drawings are not necessarily to scale and may be exaggerated to better illustrate the important features of the invention. Dimensions disclosed or shown are exemplary only. In the drawings, like reference numerals may designate like parts throughout the different views, wherein:

FIG. 1 shows a front upper right isometric view of the caddy of the present invention.

FIG. 2 shows a front view of the caddy of the present invention.

FIG. 3 shows a right-side view of the caddy of the present invention, the left side being a mirror image thereof.

FIG. 4 shows a rear view of the caddy of the present invention.

FIG. 5 shows a top view of the caddy of the present invention.

FIG. 6 shows a bottom view of the caddy of the present invention.

FIG. 7 shows an isometric view of a paint container having the caddy of the present invention positioned along its top rim.

FIG. 8 shows a front upper right isometric view of a second embodiment of the caddy of the present invention.

FIG. 9 shows a front upper right isometric view of a third embodiment of the caddy of the present invention.

FIG. 10 shows a front upper tight isometric view of a fourth embodiment of the caddy of the present invention.

### DETAILED DESCRIPTION OF THE INVENTION

The following description of the preferred embodiment(s) is merely exemplar/in nature and is in no way intended to limit the invention, its application, or its uses.

The device discussed herein, generally speaking simply a caddy, offers significant improvements over the prior art. The caddy of the present invention hangs on the outer rim of the paint container and consists of an inner portion that resides within the space defined by the top rim of the paint container and an outer portion that resides outside the space defined by the top rim. The inner portion is generally a reservoir designed to hold a measure of paint while being large enough to contain a paintbrush. Additionally, the inner portion may contain a magnet that may secure the paintbrush above the reservoir, the magnet attracting the metal band found on the paintbrush that secures the brushes to the handle of the paintbrush. The inner portion may also comprise a planar wall having an irregular surface whereon a paint roller may be rolled upon to remove excess paint from the roller and to evenly distribute the paint in the roller. The outer portion, in the preferred embodiment, may consist of a deck containing cutouts or other features wherein tools may be inserted into and be secured to the deck. In other embodiments, the outer portion may consist of a second reservoir that serves a similar purpose to the inner portion's reservoir but contains a second color of paint or may comprise a handle so that the painter may lift the caddy from the rim of the container and carry the caddy in one hand while applying paint with the other for touchup work. Finally, the caddy of the present invention is sized so that two caddies may be placed on the top rim of a 2-gallon, or larger, paint container.

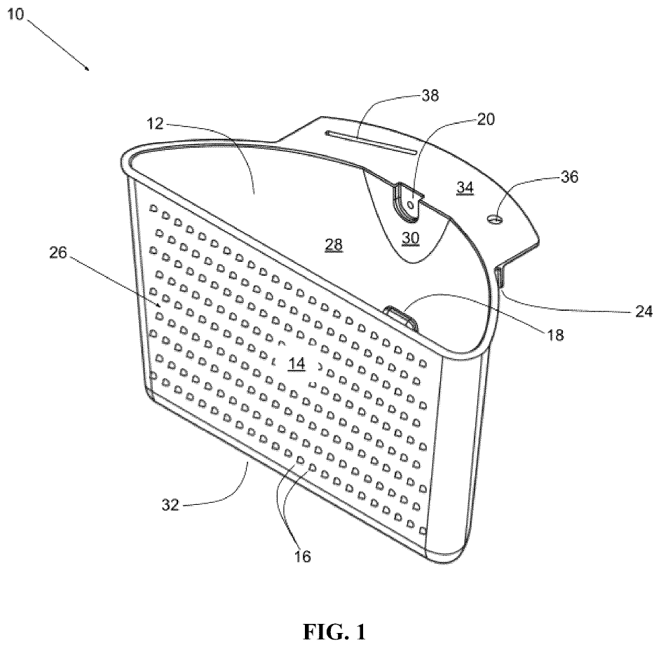

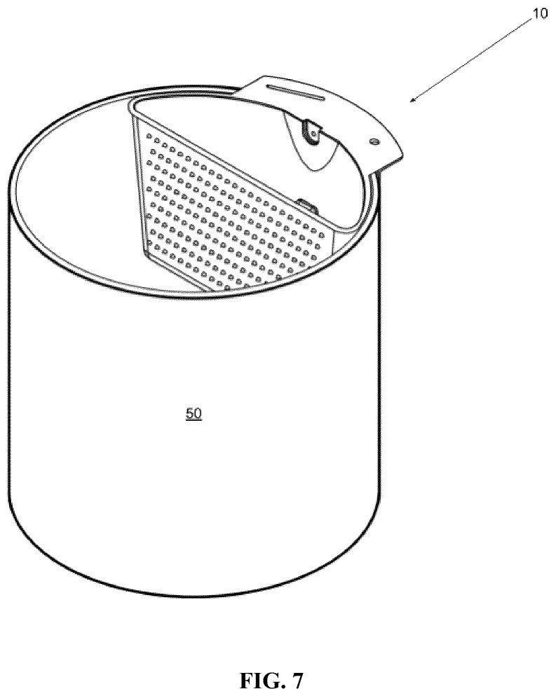

FIG. 1 shows an isometric view of caddy 10 of the preferred embodiment. Caddy 10 is designed to rest on the top rim of paint container 50 it has been placed on as shown in FIG. 7. As shown in FIG. 7, caddy 10 has a portion that resides within paint container 50 and a portion that resides outside of paint container 50. The inner portion, roughly speaking, is a container having a closed bottom, an open top, and two walls. From the top or the bottom view, the first wall may be seen as an arc of a circle while the second wall may be seen as a chord of that same circle. Thus, the top and the bottom of caddy 10, two-dimensionally, appear as circular segments with the bottom circular segment being slightly smaller than the top circular segment to allow for stacking of caddy 10. The first wall will be referenced as rear wall 28 while the second wall will be referenced as front wall 26. The diameter of rear wall 28 and the top rim of paint container 50 are similar enough so that caddy 10 may be hung about the top rim of paint container 50 as shown in FIG. 7. Caddy 10 is secured along the top rim of paint container 50 as the outer surface of rear wall 28 abuts the inner surface of paint container 50 and the outer surface of paint container 50 abuts the inner surface of flanges 24. Within the limits of bottom 32, rear wall 28, and front wall 26, is reservoir 12. As the top of reservoir 12 is open, reservoir 12 may contain any number of items such as paintbrushes, a cell phone, markers, and other such tools, but will generally contain paint. Within reservoir 12 is stop 18. It may be seen that the dimensions of bottom 32 are slightly smaller than the dimensions of the top of caddy 10. This will allow multiple caddies to be stacked one atop of the other. When multiple caddies are stacked together, it may be difficult to pull them apart as the outer surfaces of the upper caddy's front wall 26 and rear wall 28 come into contact with the inner surfaces of the lower caddy's front wall 26 and rear wall 28. It may be difficult to overcome the friction forces of these surfaces when pulling two stacked caddies apart as well as the vacuum that may be created. The presence of stop 18 prevents the caddies from being stacked too tightly with one another by reducing the distance the upper caddy may be inserted into the lower caddy and thereby reducing the amount of surface area that is in contact between the two caddies. Thus stop 18 ensures that caddies that are stacked together may be easily separated from one another. Within reservoir 12 is also found seat 20. Seat 20 provides a recess on the interior surface of rear wall 28 where a magnet may reside. The presence of a magnet allows the painter to secure, and make easily accessible, a preferred tool that comprises a ferromagnetic metal, generally a paintbrush. Rear wall 28 may have more than one seat 20 to secure more than one preferred tool. As seat 20 is a recess in the interior surface of rear wall 28, it is a protrusion on the exterior surface of rear wall 28. The protrusion of seat 20 on the exterior surface of rear wall 28 will prevent the top rim of paint container 50 from entering the channel formed between the exterior surface of rear wall 28 and the interior surface of flanges 24 if the curvature of rear wall 28 is to remain uniform, Therefore, it is necessary to place seat 20 within planar region 30 that surrounds seat 20, Planar region 30 interrupts the curvature of rear wall 28 and positions seat 20 so that it does not protrude into the channel, thus allowing the top rim of paint container 50 to fully occupy the channel. The outer surface of front wall 26 consists largely of roller distribution panel 14. Although the surface of roller distribution panel 14 is generally planar, a multitude of cones 16, arranged in roughly a matrix, exists on the surface to render the surface of roller distribution panel 14 irregular. Alternating rows of the matrix of cones 16 are horizontally offset from one another. To remove excess paint on the roller after it has been dipped into a paint container containing paint and to uniformly distribute the paint about the roller, the painter may roll the paint roller on the surface of roller distribution panel 14. The surface of roller distribution panel 14, being irregular, will remove excess paint from the roller and uniformly distribute the paint about the roller of the paint roller, Extending from the top edge of rear wall 28 is found deck 34. Deck 34 may extend along the entire length of the rim of rear wall 28 or just a portion of the rim of rear wall 28 and may be utilized to secure one or more tools. In the embodiment shown here, deck 34 contains cutouts slot 38 and hole 36 where slot 38 may be used to secure a putty knife and hole 36 may be used to secure a screwdriver. Other arrangements or sizes of cutouts exist that may suppor tools other than putty knives or screwdrivers. Moreover, features other than cutouts may be present on deck 34, such as clips, magnets, or recesses, that may be preferred for the purpose of securing tools.

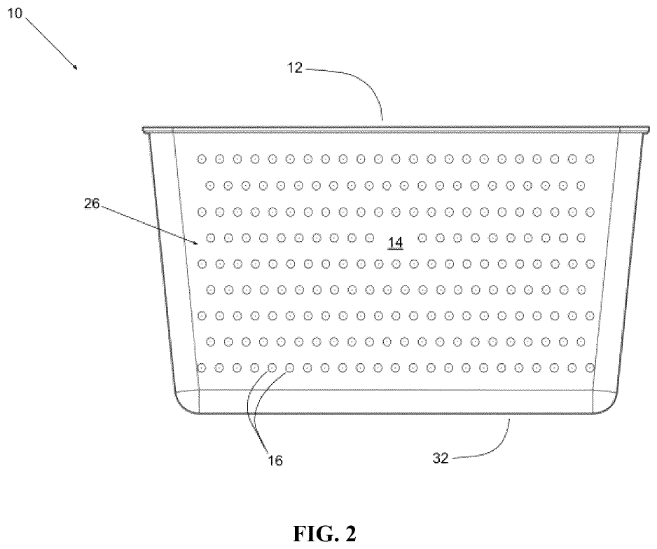

FIG. 2 shows the front view of caddy 10 which consists of front wall 26. Front wall 26 in turn consists of roller distribution panel 14. Although the surface of roller distribution panel 14 is generally planar, a multitude of cones 16, arranged in roughly a matrix, exists on the surface to render the surface of roller distribution panel 14 irregular, Alternating rows of the matrix of cones 16 are horizontally offset from one another. To remove excess paint on the roller after it has been dipped into a paint container containing paint and to uniformly distribute the paint about the roller, the painter may roll the paint roller on the surface of roller distribution panel 14. The surface of roller distribution panel 14, being irregular, will remove excess paint from the roller and uniformly distribute the paint about the roller of the paint roller. Additionally, it may-be seen that the dimensions of bottom 32 are smaller than the dimensions of the top of caddy 10 to allow for stacking.

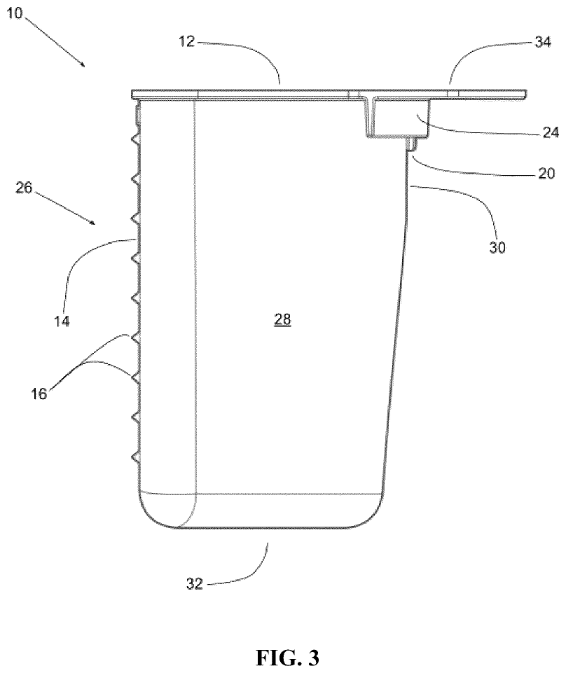

FIG. 3 shows a right side view of caddy 10 with the left side being a mirror image thereof. Here may be seen cones 16 located on roller distribution panel 14 which is found on front wall 26. Rear wall 28 connects the ends of front wall 26 and along with bottom 32 forms reservoir 12. Seat 20 provides a recess on the interior surface of rear wall 28 where a magnet may reside. The presence of a magnet allows the painter to secure, and make easily accessible, a preferred tool that comprises a ferromagnetic metal, generally a paintbrush. Rear wall 28 may have more than one seat 20 to secure more than one preferred tool. As seat 20 is a recess in the interior surface of rear wall 28, it is a protrusion on the exterior surface of rear wall 28. The protrusion of seat 20 on the exterior surface of rear wall 28 will prevent the top rim of paint container 50 from entering the channel formed between the exterior surface of rear wall 28 and the interior surface of flanges 24 if the curvature of rear wall 28 is to remain uniform. Therefore, it is necessary to place seat 20 within planar region 30 that surrounds seat 20. Planar region 30 interrupts the curvature of rear wall 28 and positions seat 20 so that it does not protrude into the channel, thus allowing the top rim of paint container 50 to fully occupy the channel. The top rim of paint container 50, when caddy 10 is positioned thereon, will pass between the channel formed by interior surface of flanges 24 and the exterior surface of rear wall 28. The channel will prevent caddy 10 from falling into or outside of paint container 50. Extending from the top edge of rear wall 28 is found deck 34. Deck 34 may extend along the entire length of the rim of rear wall 28 or just a portion of the rim of rear wall 28 and may be utilized to secure one or more tools. In the embodiment shown here, deck 34 contains cutouts slot 38 and hole 36 where slot 38 may be used to secure a putty knife and hole 36 may be used to secure a screwdriver. Other arrangements or sizes of cutouts exist that may support tools other than putty knives or screwdrivers. Moreover, features other than cutouts may be present on deck 34, such as clips, magnets, or recesses, that may be preferred for the purpose of securing tools.

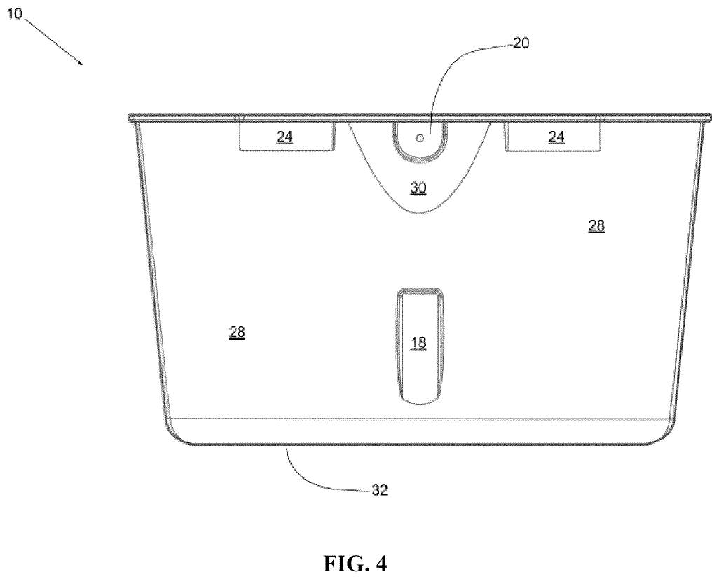

FIG. 4 shows the back of caddy 10 of the present invention. The back of caddy 10 is dominated by rear wall 28 which has a diameter similar to the diameter of the top rim of paint container 50. Also visible in FIG. 4 are flanges 24 which have a slightly larger diameter than rear wall 28. A channel is present between the exterior surface of rear wall 28 and the interior surface of flanges 24 wherein the top rim of paint container 50 may be inserted therein. Rear wall 28 and flanges 24 work in conjunction with each other to secure caddy 10 on the top rim of paint container 50. At the extent of the arc of rear wall 28, is found stop 18. It may be seen that the dimensions of bottom 32 are slightly smaller than the dimensions of the top of caddy 10. This will allow multiple caddies to be stacked one atop of the other. When multiple caddies are stacked together, it may be difficult to pull them apart as the outer surfaces of the upper caddy's front wall 26 and rear wall 28 come into contact with the inner surfaces of the lower caddy's front wall 26 and rear wall 28. It may be difficult to overcome the friction forces of these surfaces when pulling two stacked caddies apart as well as the vacuum that may be created. The presence of stop 18 prevents the caddies from being stacked too tightly with one another by reducing the distance the upper caddy may be inserted into the lower caddy and thereby reducing the amount of surface area that is in contact between the two caddies. Thus stop 18 ensures that caddies that are stacked together may be easily separated from one another. Seat 20 provides a recess on the interior surface of rear wall 28 where a magnet may reside. The presence of a magnet allows the painter to secure, and make easily accessible, a preferred tool that comprises a ferromagnetic metal, generally a paintbrush. Rear wall 28 may have more than one seat 20 to secure more than one preferred tool. As seat 20 is a recess in the interior surface of rear wall 28, it is a protrusion on the exterior surface of rear wall 28. The protrusion of seat 20 on the exterior surface of rear wall 28 will prevent the top rim of paint container 50 from entering the channel formed between the exterior surface of rear wall 28 and the interior surface of flanges 24 if the curvature of rear wall 28 is to remain uniform. Therefore, it is necessary to place seat 20 within planar region 30 that surrounds seat 20. Planar region 30 interrupts the curvature of rear wall 28 and positions seat 20 so that it does not protrude into the channel, thus allowing the top rim of paint container 50 to fully occupy the channel.

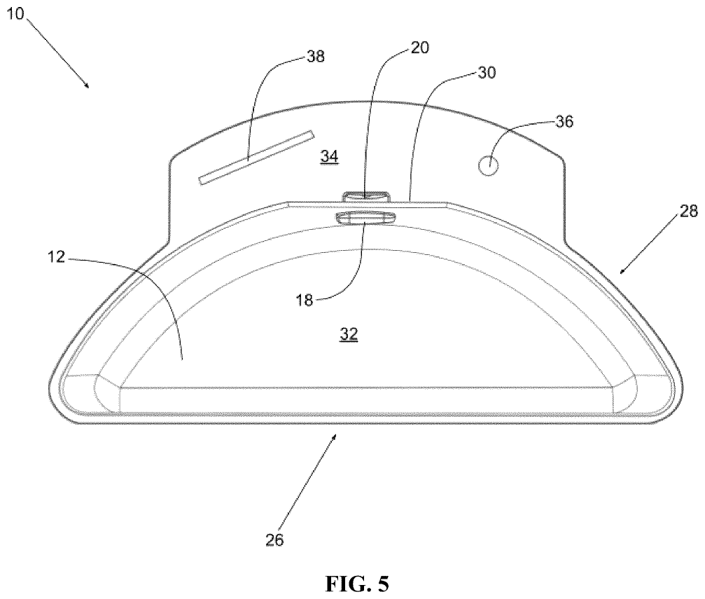

FIG. 5 shows a top view of caddy 10. Reservoir 12 is bounded by bottom 32, front wall 26, and rear wall 28 and may be used to hold paint or tools that are needed by the painter. Within reservoir 12 is found stop 18. It may be seen that the dimensions of bottom 32 are slightly smaller than the dimensions of the top of caddy 10. This will allow multiple caddies to be stacked one atop of the other. When multiple caddies are stacked together, it may be difficult to pull them apart as the outer surfaces of the upper caddy's front wall 26 and rear wall 28 come into contact with the inner surfaces of the lower caddy's front wall 26 and rear wall 28. It may be difficult to overcome the friction forces of these surfaces when pulling two stacked caddies apart as well as the vacuum that may be created. The presence of stop 18 prevents the caddies from being stacked too tightly with one another by reducing the distance the upper caddy may be inserted into the lower caddy and thereby reducing the amount of surface area that is in contact between the To caddies. Thus stop 18 ensures that caddies that are stacked together may be easily separated from one another. Seat 20 provides a recess on the interior surface of rear wall 28 where a magnet may reside. The presence of a magnet allows the painter to secure, and make easily accessible, a preferred tool that comprises a ferromagnetic metal, generally a paintbrush. Rear wall 28 may have more than one seat 20 to secure more than one preferred tool. As seat 20 is a recess in the interior surface of rear wall 28, it is a protrusion on the exterior surface of rear wall 28. The protrusion of seat 20 on the exterior surface of rear wall 28 will prevent the top rim of paint container 50 from entering the channel formed between the exterior surface of rear wall 28 and the interior surface of flanges 24 if the curvature of rear wall 28 is to remain uniform. Therefore, it is necessary to place seat 20 within planar region 30 that surrounds seat 20. Planar region 30 interrupts the curvature of rear wall 28 and positions seat 20 so that it does not protrude into the channel, thus allowing the top rim of paint container 50 to fully occupy the channel. Deck 34 may extend along the entire length of the rim of rear wall 28 or just a portion of the rim of rear wall 28 and may be utilized to secure one or more tools. In the embodiment shown here, deck 34 contains cutouts slot 38 and hole 36 where slot 38 may be used to secure a putty knife and hole 36 may be used to secure a screwdriver. Other arrangements or sizes of cutouts exist that may support tools other than putty knives or screwdrivers. Moreover, features other than cutouts may be present on deck 34, such as clips, magnets, or recesses, that may be preferred for the purpose of securing tools. Cones 16 and roller distribution panel 14 are not visible here as a lip running along the top rim of front wall 26 Obscures their view.

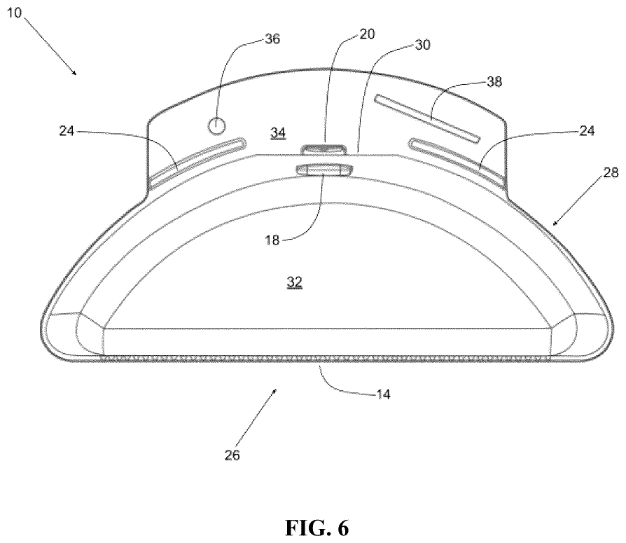

FIG. 6 shows a bottom view of caddy 10. Excluding deck 34, the bottom view of caddy 10 has the geometric appearance of a circular segment. The circular segment is bounded by front wall 26 and rear wall 28, Front wall 26 consists of roller distribution panel 14. Although the surface of roller distribution panel 14 is generally planar, a multitude of cones 16; arranged in roughly a matrix, exists on the surface to render the surface of roller distribution panel 14 irregular. Alternating rows of the matrix of cones 16 are horizontally offset from one another. To remove excess paint on the roller after it has been dipped into a paint container containing paint and to uniformly distribute the paint about the roller, the painter may roll the paint roller on the surface of roller distribution panel 14. The surface of roller distribution panel 14, being irregular, will remove excess paint from the roller and uniformly distribute the paint about the roller of the paint roller. The surface of rear wall 28 is generally smooth except for two features. The first feature is stop 18 and is shown in FIG. 6 as being at the apex of the arc on rear wall 28. It may be seen that the dimensions of bottom 32 are slightly smaller than the dimensions of the top of caddy 10. This will allow multiple caddies to be stacked one atop of the other. When multiple caddies are stacked together, it may be difficult to pull them apart as the outer surfaces of the upper caddy's front wall 26 and rear wall 28 come into contact with the inner surfaces of the lower caddy's front wall 26 and rear wall 28. It may be difficult to overcome the friction forces of these surfaces when pulling two stacked caddies apart as well as the vacuum that may be created. The presence of stop 18 prevents the caddies from being stacked too tightly with one another by reducing the distance the upper caddy may be inserted into the lower caddy and thereby reducing the amount of surface area that is in contact between the two caddies. Thus stop 18 ensures that caddies that are stacked together may be easily separated from one another. The second feature is seat 20 which is also found at the apex of the arc on rear wall 28. Seat 20 provides a recess on the interior surface of rear wall 28 where a magnet may reside. The presence of a magnet allows the painter to secure, and make easily accessible, a preferred tool that comprises a ferromagnetic metal, generally a paintbrush. Rear wall 28 may have more than one seat 20 to secure more than one preferred tool. As seat 20 is a recess in the interior surface of rear wall 28, it is a protrusion on the exterior surface of rear wall 28. The protrusion of seat on the exterior surface of rear wall 28 will prevent the top rim of paint container 50 from entering the channel formed between the exterior surface of rear wall 28 and the interior surface of flanges 24 if the curvature of rear wall 28 is to remain uniform. Therefore, it is necessary to place seat 20 within planar region 30 that surrounds seat 20. Planar region 30 interrupts the curvature of rear wall 28 and positions seat 20 so that it does not protrude into the channel, thus allowing the top rim of paint container 50 to fully occupy the channel. Also visible in FIG. 6 are flanges 24 which are designed to engage with the outer surface of paint container 50 that caddy has been set on. In this embodiment, two clips are shown at either end of deck 34. However, other arrangements are possible that will accomplish the same purpose as the arrangement of flanges 24 here. Finally, the bottom of deck 34 is shown. Deck 34 may extend along the entire length of the rim of rear wall 28 or just a portion of the rim of rear wall 28 and may be utilized to secure one or more tools. In the embodiment shown here, deck 34 contains cutouts slot 38 and hole 36 where slot 38 may be used to secure a putty knife and hole 36 may be used to secure a screwdriver. Other arrangements or sizes of cutouts exist that may support tools other than putty knives or screwdrivers. Moreover, features other than cutouts may be present on deck 34, such as clips, magnets, or recesses, that may be preferred for the purpose of securing tools.

FIG. 7 shows an isometric view of paint container 50 having caddy 10 positioned along its top rim.

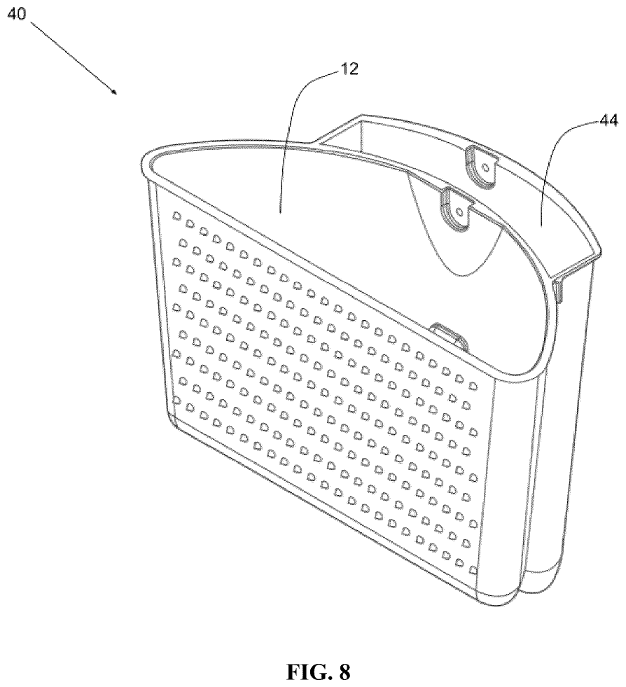

FIG. 8 shows an isometric view of second embodiment 40 of caddy 10. In this embodiment, deck 34 is removed and replaced by secondary reservoir 44. This embodiment would allow the painter to add another color separate from the color in reservoir 12 or to use secondary reservoir 44 to hold additional tools or hardware. Secondary reservoir 44 may also have a magnet just as reservoir 12 has a magnet.

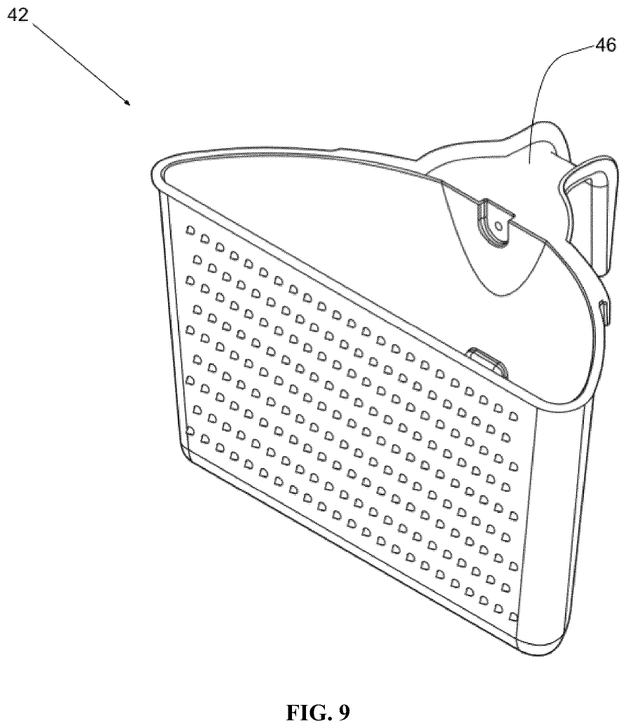

FIG. 9 shows an isometric view of third embodiment 42 of caddy 10. In this embodiment, deck 34 is removed and replaced by handle 46. This embodiment would allow the painter to carry caddy 10 by handle 46 for touch-up work.

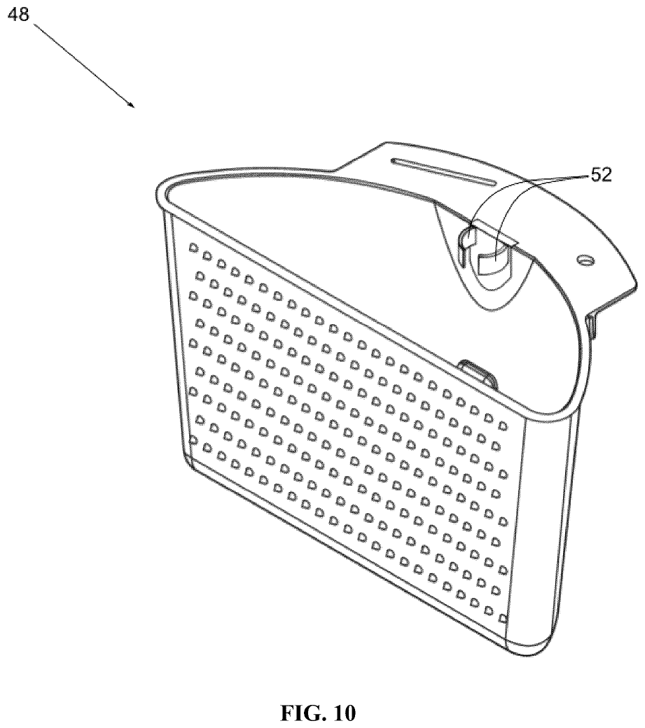

FIG. 10 shows an isometric view of fourth embodiment 48 of caddy 10. In this embodiment, the recess of seat 20 holds clip 52 in place of magnet 22. Clip 52 is configured to secure a paintbrush by its handle or other tool if so desired.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What I claim is:

1. A caddy for use on a paint container the caddy comprising:
a rear wall being a wall in the form of an arc having a height, top edge, bottom edge, left edge, and right edge;
a front wall being a planar having a height, top edge, bottom edge, a left edge that joins said rear wall's left edge, and a right edge that joins said rear wall's right edge;
a bottom joining said rear wall and said front wall's bottom edges forming a first reservoir therein;
one or more flanges aligned with and proximate to the top edge of said rear wall, forming a channel between said flanges and rear wall, wherein the rim of said paint container may be inserted into; and
one or more planar regions about said rear wall each comprising a recess holding a magnet or a clip, said planar regions being long enough so that said recess does not intrude into said channel.

2. The caddy of claim 1 further comprising a handle attached to the top edge of said rear wall so that said caddy may be easily transported.

3. The caddy of claim 1 further comprising a deck attached to the top edge of said rear wall, said deck comprises anyone or any combination of: cutouts, recesses, clips, or magnets.

4. The caddy of claim 1 further comprising a second reservoir opposite said first reservoir.

5. The caddy of claim 1 wherein said front wall further comprises an arrangement of cones on the surface opposite said reservoir.

6. The caddy of claim 1 wherein the bottom dimensions of said caddy are smaller than the top dimensions of said caddy allowing said caddies to be stacked.

7. The caddy of claim 6 further comprising a stop, said stop being a protrusion into said reservoir on said rear wall to prevent said caddies from being stacked too closely together.

8. A caddy for use on a paint container the caddy comprising:
a rear wall being a wall in the form of an arc having a height, top edge, bottom edge, left edge, and right edge;
a front wall being a planar wall having a height, top edge, bottom edge, a left edge that joins said rear wall's left edge, and a right edge that joins said rear wall's right edge;
a bottom joining said rear wall and said front wall's bottom edges forming a first reservoir therein wherein the bottom dimensions of said caddy are smaller than the top dimensions of said caddy allowing said caddies to be stacked;
a stop, said stop being a protrusion into said reservoir on said rear wall to prevent said caddies from being stacked too closely together;
one or more flanges aligned with and proximate to the top edge of said rear wall, forming a channel between said flanges and rear wall, wherein the rim of said paint container may be inserted into;
a deck attached to the top edge of said rear wall, said deck comprises anyone or any combination of: cutouts, recesses, clips, or magnets; and
one or more planar regions about said rear wall each comprising a recess containing a magnet or a clip, said planar regions being long enough so that said recess does not intrude into said channel.
